(19) United States
(12) Patent Application Publication
(10) Pub. No.: US 2009/0279138 A1
(43) Pub. Date: Nov. 12, 2009

(54) IMAGE PROCESSING SYSTEM, METHOD OF CONTROLLING THE SAME, AND STORAGE MEDIUM

(75) Inventor: Yoshitaka OBA, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/437,688

(22) Filed: May 8, 2009

(30) Foreign Application Priority Data
May 8, 2008 (JP) 2008-122179

(51) Int. Cl. G06F 15/00

(52) U.S. Cl. 358/1.15; 358/1.16

(57) ABSTRACT

An image processing system which makes it possible to find a user-friendly substitute apparatus with ease. The image processing system includes a plurality of image processing apparatuses. An operation history management module collects operation information indicative of details of operations executed in each of the image processing apparatuses and stores the collected operation information as operation history information in a database. Search conditions for searching for a second image processing apparatus to be substituted for a first image processing apparatus, from among the image processing apparatuses, are input via a search condition input screen. A management server searches for image processing apparatuses satisfying the search conditions from among the image processing apparatuses by referring to the operation history information. The management server generates search result screen information for causing a display section of the first image processing apparatus to display results of the search.

### BACKGROUND OF THE INVENTION

1. Field of the Invention

The present invention relates to an image processing system which makes it possible to use a plurality of image processing apparatuses, a method of controlling the image processing system, and a computer-readable storage medium storing a program for implementing the method.

2. Description of the Related Art

Conventionally, there has been proposed a cooperation technique for causing a plurality of apparatuses to perform a desired function in a cooperative manner on a network via which the apparatuses are interconnected. For example, when printing being carried out by one printing apparatus is interrupted due to occurrence of a trouble or the like in the apparatus, by using the above-mentioned technique, it is possible to cause another printing apparatus having the same functions as those of the one printing apparatus to carry out a remaining part of the printing (see Japanese Patent Laid-Open Publication No. 2002-278735).

In the above-mentioned cooperation technique, when a trouble occurs in an apparatus currently in use and a substitute apparatus is to be sought for, the apparatus to be found is required to have functions corresponding to those of the apparatus currently in use. However, unless sufficient apparatus information on other apparatuses having such functions is provided and an exact search key is used, it is sometimes difficult to find out a user-friendly substitute apparatus.

### SUMMARY OF THE INVENTION

The present invention provides an image processing system which makes it possible to find a user-friendly substitute apparatus with ease, a method of controlling the image processing system, and a storage medium storing a program for implementing the method.

In a first aspect of the present invention, there is provided an image processing system comprising an operation history information storage unit configured to collect operation information indicative of details of operations executed in each of a plurality of image processing apparatuses and store the collected operation information as operation history information, an input unit configured to input search conditions for searching for a second image processing apparatus to be substituted for a first image processing apparatus, from among the plurality of image processing apparatuses, a search unit configured to search for image processing apparatuses satisfying the search conditions from among the plurality of image processing apparatuses by referring to the operation history information stored in the operation history information storage unit, and a display processing unit configured to carry out processing for causing a display unit to display results of the search by the search unit.

In a second aspect of the present invention, there is provided a method of controlling an image processing system including a plurality of image processing apparatuses, comprising collecting operation information indicative of details of operations executed in each of the plurality of image processing apparatuses and storing the collected operation information as operation history information, inputting search conditions for searching for a second image processing apparatus to be substituted for a first image processing apparatus, from among the plurality of image processing apparatuses, searching for image processing apparatuses satisfying the search conditions from among the plurality of image processing apparatuses by referring to the stored operation history information, and carrying out processing for causing a display unit to display results of the search.

In a third aspect of the present invention, there is provided a computer-readable storage medium storing a program for causing a computer to execute a method of controlling an image processing system including a plurality of image processing apparatuses, wherein the method comprises collecting operation information indicative of details of operations executed in each of the plurality of image processing apparatuses and storing the collected operation information as operation history information, inputting search conditions for searching for a second image processing apparatus to be substituted for a first image processing apparatus, from among the plurality of image processing apparatuses, searching for image processing apparatuses satisfying the search conditions from among the plurality of image processing apparatuses by referring to the stored operation history information, and carrying out processing for causing a display unit to display results of the search.

According to the present invention, it is possible to find a user-friendly substitute apparatus with ease, based on operation history information storing operation information indicative of details of operations carried out by the plurality of image processing apparatuses.

The features and advantages of the invention will become more apparent from the following detailed description taken in conjunction with the accompanying drawings.

### BRIEF DESCRIPTION OF THE DRAWINGS

FIG. 1 is a schematic conceptual diagram of an image processing system according to a first embodiment of the present invention.

FIG. 2 is a block diagram of a management server appearing in FIG. 1.

FIG. 3 is a diagram showing the software configuration of the management server.

FIG. 4 is a schematic diagram useful in explaining an operation performed by a system management program (operation history management) appearing in FIG. 3, so as to collect operation information on devices.

FIG. 5 is a flowchart of an operation information-issuing process executed by an MFP appearing in FIG. 1.

FIG. 6 is a flowchart of a device operation information-collecting process executed by the system management program (operation history management).

FIGS. 7A, 7B, and 7C are views useful in explaining the functions of an operating section of the MFP appearing in FIG. 1.

FIG. 8 is a view of an example of a device list screen displayed on a display section of the MFP so as to show devices found by device search by the management server.

FIG. 9 is a flowchart of a device search process executed by the management server.

FIG. 10 is a view of an example of a screen displayed on the operating section so as to show candidate substitute devices found by the device search by the management server.

FIG. 11 is a flowchart of a substitution request process executed by the management server.

FIG. 12 is a flowchart of a substitution process executed by a candidate substitute device having received a substitution request from the management server.

FIG. 13 is a flowchart of a device search process executed by a management server of an image processing system according to a second embodiment of the present invention.

### DETAILED DESCRIPTION OF THE EMBODIMENTS

The present invention will now be described in detail below with reference to the accompanying drawings showing embodiments thereof.

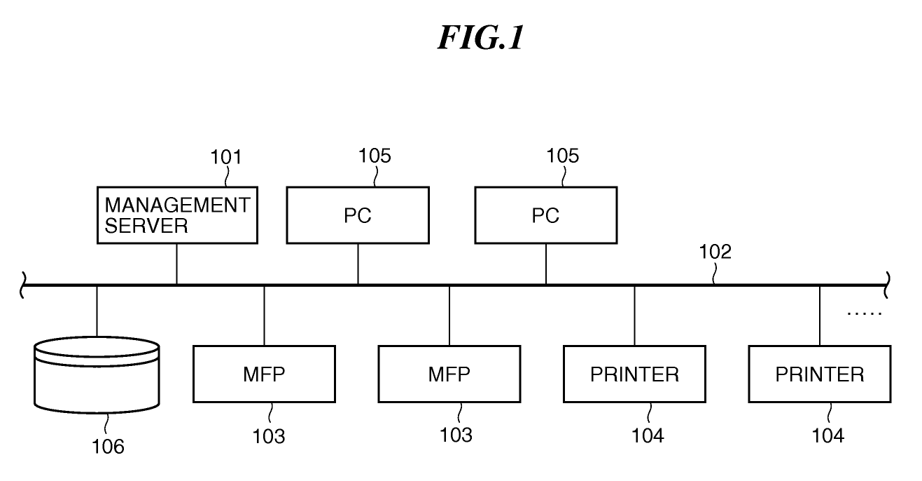

FIG. 1 is a schematic conceptual diagram of an image processing system according to a first embodiment of the present invention.

As shown in FIG. 1, the image processing system includes a management server 101 connected to a network 102, such as a LAN (Local Area Network). Connected to the network 102 are a plurality of devices (image processing apparatuses), such as a plurality of MFPs 103, a plurality of printers 104, a plurality of PCs (Personal Computers) 105, and an external storage device 106.

The management server 101 manages not only the devices (apparatuses) connected to the network 102 and users using these, but also the operating states of the respective devices and the respective users' states of use. Each of the MFPs 103 is a multi-function apparatus provided with a plurality of functions including a copy function, a print function, a scan function, and a FAX function. Each of the PCs 105 is capable of transferring image data which is generated by an application program or stored in a storage device to the MFPs 103, the printers 104, or the external storage device 106. Each MFP 103 or each printer 104 can print image data having received from another MFP 103 or another printer 10, or transmit the same by facsimile. Further, each MFP 103, each printer 104 or the external storage device 106 can store image data having received from another MFP 103 or another printer 10 in a storage device thereof.

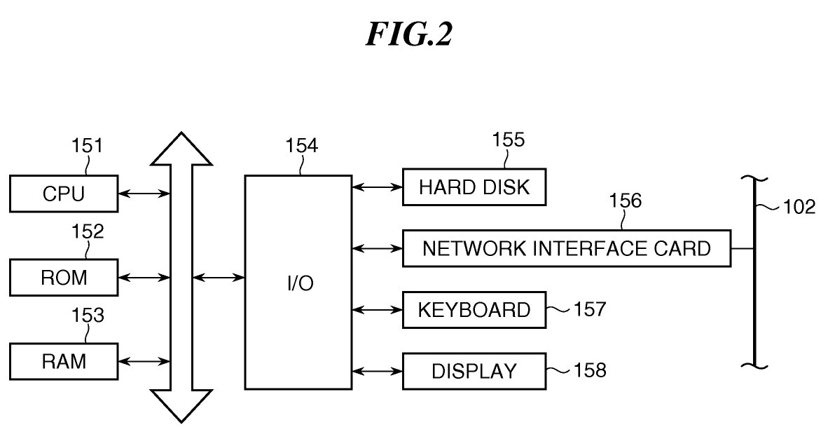

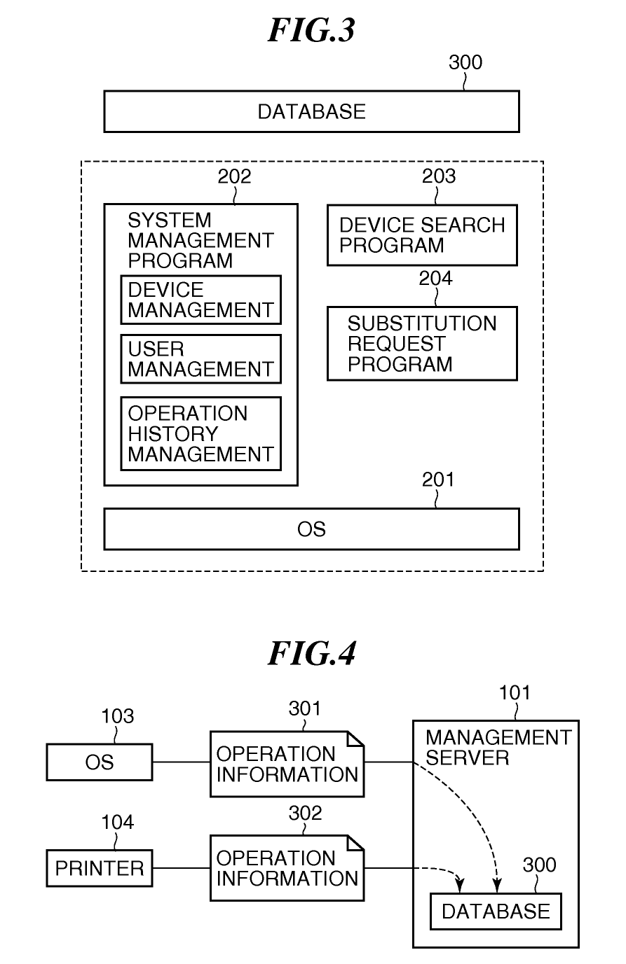

Next, the management server 101 will be described with reference to FIGS. 2 and 3. FIG. 2 is a block diagram of the management server 101 appearing in FIG. 1. FIG. 3 is a diagram showing the software configuration of the management server 101.

As shown in FIG. 2, the management server 101 is comprised of a CPU 151, a ROM 152, a RAM 153, and an input/output interface (I/O) 154. Connected to the input/output interface 154 are a hard disk 155, a network interface card 156, a keyboard 157, a display 158 and so forth. The network interface card 156 is connected to the network 102. The arrangement of the management server 101 is well known, and therefore detailed description thereof is omitted.

As shown in FIG. 3, the management server 101 causes an associated application program to be executed on an operating system (hereinafter abbreviated as OS) 201, which enables a plurality of application programs to be executed thereon and be managed thereby, to thereby provide an associated function. The OS is constructed by execution of an OS program by the CPU 151. The application programs include the three programs of a system management program 202, a device search program 203, and a substitution request program 204. The OS program and the application programs are stored in the hard disk 155. Each of these programs is read out from the hard disk 155, and is executed by the CPU 151.

The system management program 202 is executed for device management, user management, and operation history management. A device management module registers device information (a name, image processing apparatus-specific executable functions, an installation place, etc.) on each of the devices (apparatuses) connected to the network 102 in a database 300 (management information storage unit) provided in the hard disk 155, and manages the registered device information. A user management module registers user information (a user ID (identification information), a password, a user use division associated with a group of devices allocated for the user's use, etc.) on each user authorized to use the devices connected to the network 102 in the database 300, and manages the registered user information.

An operation history management module collects operation information on the devices, and stores and manages the collected operation information as operation history information in the database 300 (operation history information storage unit). The operation history information includes operating state information (execution date and time of each operation, functions used for execution of the operation (function information), settings for each of the operations, etc.) on the devices and use status information on users (users who executed the respective operations). The operation history management module manages the operation history information such that as to each case of occurrence of a trouble in one device, a device which a user having operated the one device moved to next and the kind of an operation which the user subsequently carried out can be identified. The operation history information is stored in the database 300 in association with the device information and the user information.

The device search program 203 refers to the operation history information in the database 300 based on a search request from a device (apparatus) currently operated by the user, to thereby search for devices (apparatuses) associated with operation history information satisfying a search key input by the user. One of the devices found by this search can be a substitute device (second image processing apparatus) for the device (first image processing apparatus) which is used or is being used by the user for work. The results of the search for the candidate substitute devices are sent to the device (apparatus) currently operated by the user, and are displayed on a display unit of the apparatus (i.e. the operating section of an MFP or a printer, or the display of a PC).

The substitution request program 204 is executed to request a candidate substitute device found by the device search program 203 to take the place of the apparatus currently executing an operation and continue the operation being executed by the device.

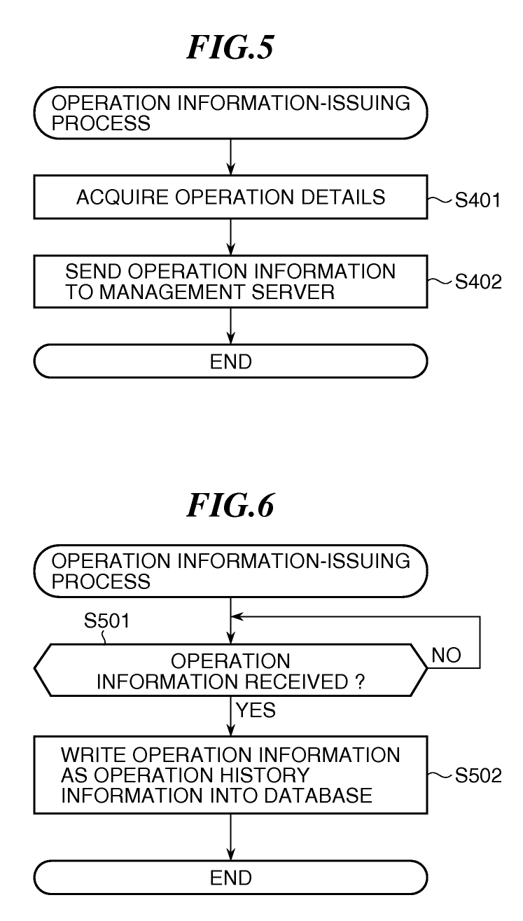

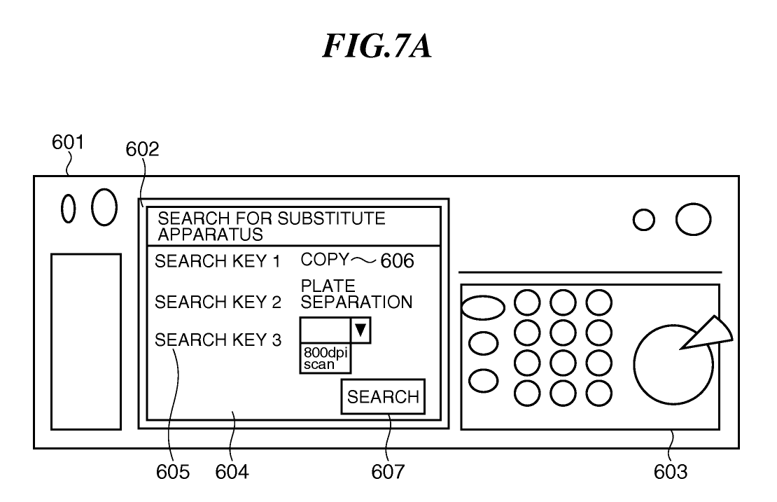

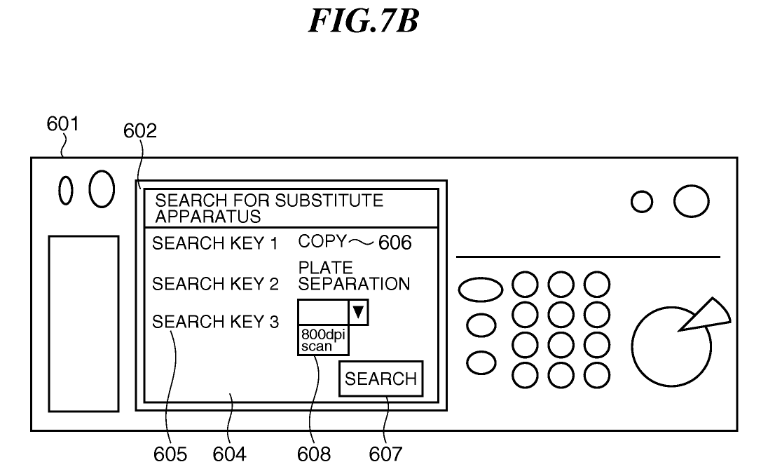

Next, collection of operation information on the devices (apparatuses) by the system management program 202 (operation history management module) will be described with reference to FIGS. 4 to 6. FIG. 4 is a schematic diagram useful in explaining an operation executed by the system management program 202 (operation history management module) appearing in FIG. 3, so as to collect operation information on the devices (apparatuses). FIG. 5 is a flowchart of an operation information-issuing process executed by the MFP 103 appearing in FIG. 1. FIG. 6 is a flowchart of a device operation information-collecting process executed by the system management program 202 (operation history management) appearing in FIG. 3.

As shown in FIG. 4, each MFP 103 and each printer 104 on the network 102 acquires details of respective executed operations and send operation information 301 and 302 indicative of the operation details to the management server 101 via the network 102. For example, when a copy operation is executed by the MFP 103, operation details including information indicative of operational conditions concerning the copy operation and a user who carried out the copy operation are acquired after completion of the copy operation and are sent as operation information to the management server 101. Further, when the power is turned on or turned off, operation information indicative of operational conditions caused by the power-on or the power-off is transmitted. Further, when a trouble, such as a sheet jam, occurs or when the trouble is eliminated, similarly, operation information indicative of operational conditions caused by the occurrence or elimination of the trouble is transmitted.

Upon receipt of operation information from each of the devices (apparatuses), the management server 101 (operation history management module) writes the received operation information on each device into the database 300 to store the information therein, as operation history information.

When one of the MFPs 103 on the network 102 completes an operation, the MFP 103 starts the operation information-issuing process shown in FIG. 5, and first acquires operation details (step S401). The acquired operation details include-information indicative of a user who carried out the operation, a function operated in the MFP 103, and settings configured for the function. The user who carried out the operation is identified using e.g. information on user authentication performed prior to using the MFP 103. Then, the MFP 103 sends operation information indicative of the operation details to the management server 101 via the network 102 (step S402), followed by terminating the present process.

Although in the above description, the MFP 103 issues operation information, not only each MFP 103, but also each printer 104 executes the FIG. 5 operation information-issuing process to issue operation information.

On the other hand, the management server 101 executes the operation information-collecting process shown in FIG. 6. Upon receipt of operation information from one of the MFPs 103 or the printers 104 (step S501), the management server 101 writes the received operation information as operation history information into the database 300 (step S502). In this case, the operation history information is written into the database 300 in association with the name of the associated device (apparatus), and then the management server 101 terminates the present process.

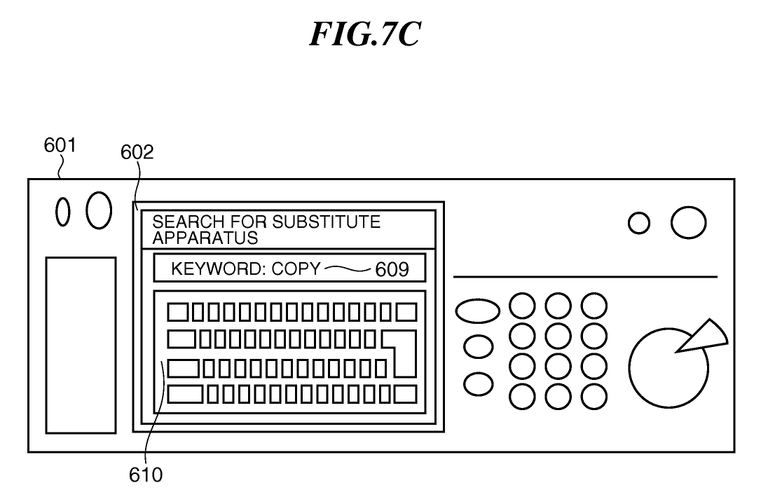

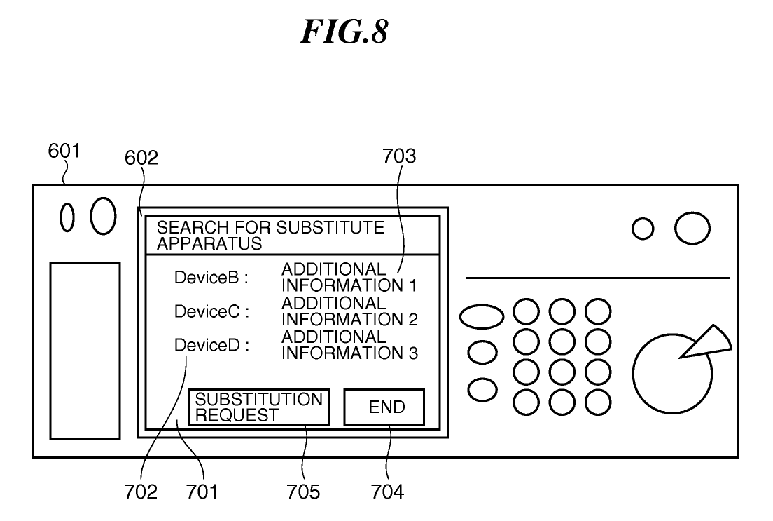

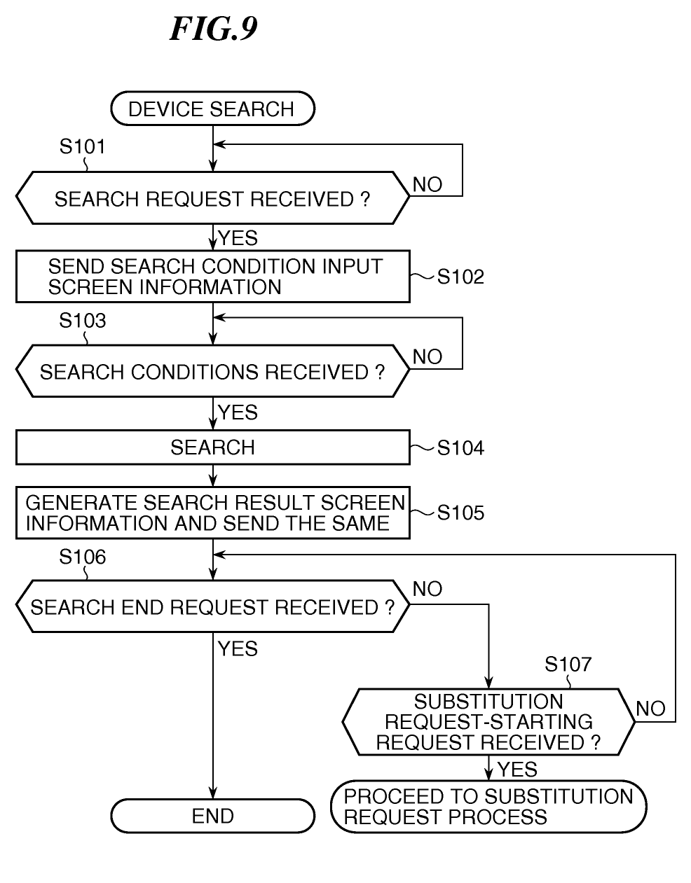

Next, device search by the management server 101 (device search program 203) will be described with reference to FIGS. 7A, 7B, and 7C to 9. FIGS. 7A, 7B, and 7C are views useful in explaining the functions of an operating section 601 of the MFP 103. FIG. 8 is a view of an example of a device list screen displayed on a display section 602, appearing e.g. in FIG. 7A, of the MFP 103 so as to show devices (apparatuses) found by device search by the management server 101. FIG. 9 is a flowchart of a device search process executed by the management server 101 (device search program 203).

Each of the MFPs 103 on the network 102 is provided with the operating section 601 shown in FIG. 7A. The operating section 601 is comprised of the display section 602 implemented e.g. by a liquid crystal device with a touch panel for displaying various kinds of information and soft buttons, and an operating key group 603 including a plurality of hard keys used to enter various kinds of information.

Now, let it be assumed that a trouble occurs in one of the MFPs 103 while a user is carrying out an operation (e.g. a copy operation) using the MFP 103, to interrupt the operation. Alternatively, let it be assumed that before a user starts a copy operation using one of the MFPs 103, it is determined that the MFP 103 is not suitable for the copy operation. In these cases, the user is required to search for a device (apparatus) on the network 102, which can be substituted for the MFP 103, i.e. a substitute device (apparatus) for the MFP 103. In such a case, the user operates the operating section 601 of the MFP 103 to send a search request for searching for the substitute device (i.e. the device to be substituted for the MFP 103) to the management server 101. Upon receipt of the search request, the server 101 (device search program 203) sends a search condition input screen information for use in inputting search conditions for searching for the substitute device (apparatus) to the MFP 103. The MFP 103 receives the search condition input screen information and displays a search condition input screen 604, appearing e.g. in FIG. 7A, on the display section 602. The search condition input screen may be configured according to the details of an operation currently being executed by the user or the details of the trouble having occurred. In other words, the screen may be changed according to the details of the operation being executed by the user or details of a trouble that has occurred.

The search condition input screen 604 displays a plurality of input fields 606 for inputting respective search keys 605. The method of inputting a search key in each of the input fields 606 includes a method in which a user selects a desired character string from a plurality of character strings provided in advance, using a fixed term key 608, as shown in FIG. 7B, and inputs the selected character string. Further, there is another method in which a user enters a desired character string 609 using a virtual keyboard 610 as shown in FIG. 7C.

After completing the input of one or more search keys to respective associated input fields 606, the user presses a search button 607. By depression of the search button 607, the one or more search keys thus input are sent to the management server 101, as search conditions for searching for an substitute device (apparatus).

Upon receipt of the search conditions, the management server 101 refers to the database 300 to find out devices (apparatuses) associated with operation history information satisfying the received search condition, as candidate substitute devices. For example, when the search conditions includes reading conditions, such as a scan function, a resolution of 600 dpi, and color copying, devices (apparatuses) associated with operation history information indicating that a scan operation has been performed under the reading conditions are found as candidate substitute devices. In short, candidate substitute devices are determined based on operation history including the same operation conditions, by referring to the operation history information stored in the database 300. In this case, further, the aforementioned user use division may be referred to so as to extract devices the user operating the MPP 103 is authorized to use, as candidate substitute devices. Further, when operation history information indicates that a plurality of different kinds of operations have been carried out in a similar situation, devices (apparatuses) ever selected more frequently may be preferentially extracted as candidate substitute devices. Then, the management server 101 generates search result screen information (search result information) for causing the display section 602 of the MFP 103 to display search results, and sends the generated search result screen information to the MFP 103.

Upon receipt of the search result screen information, the MFP 103 displays a search result screen 701, appearing in FIG. 8, on the display section 602 based on the search result screen information. The search result screen 701 displays the search results, an end button 704, and a substitution request button 705. The displayed search results include a name list 702 of the devices (candidate substitute devices) found by the device search, and device-specific additional information 703. Each piece of the device-specific additional information 703 includes at least pieces of information indicative of the installation place of a device (apparatus) and the functions provided for the device (apparatus). The device-specific additional information 703 is read from the database 300. The search result screen 701 appearing in FIG. 8 shows an exemplary case where three devices named Device B, Device C, and Device D, respectively, are found as candidate substitute devices by the device search.

The device-specific additional information displayed on the search result screen 701 informs the user operating the MFP 103 of the installation places, functions, etc. of the respective devices (apparatuses) found as candidate substitute devices. This enables the user to check which one of the candidate substitute devices is most suitable as a substitute for carrying out an operation desired by the user, and then move to the installation place of the most suitable device and carry out the operation using the device. Thus, the user can easily find a user-friendly substitute device. More specifically, since a substitute device is determined based on an operation history including the same operation conditions, by referring past operation history information, it is possible to find a suitable substitute device with ease without execution of complicated search or the like.

After checking on the candidate substitute devices from the search result screen, the user operating the MFP 103 can then request the management server 101 to terminate the present device search process or to cause the process to proceed from the device search process to a substitution request process. In the case of requesting the management server 101 to terminate the present process, the user presses the end button 704. By depression of the end button 704, a search termination request is sent to the management server 101, and the management server 101 having received the search termination request terminates the present process.

In the case of requesting one of the candidate substitute devices to continue the operation interrupted due to a trouble with the MFP 103, the user operating the MFP 103 presses the substitution request button 705. By depression of the substitution request button 705, a substitution request-starting request is sent to the management server 101, and the management server 101 having received the substitution request-starting request starts the substitution request process. The substitution request process will be described in detail hereinafter.

Now, it is assumed that a user operates one of the PCs 105 to thereby send image data from the PC 105 to one of the printers 104 or the MFPs 103, and the device (apparatus) having received the image data carries out printing. Further, it is assumed that then a trouble occurs in the device (apparatus) during the printing operation, and the operation is interrupted. Further, it is assumed that the user operating the PC 105 determines that the device (apparatus) performing the printing operation is not suitable for the print operation.

In this case as well, a search request is sent from the PC 105 to the management server 101 following the same procedure as described above. Based on the search request, the management server 101 finds candidate substitute devices (i.e. devices having a print function) satisfying search conditions (search keys) input by the user. Then, search results indicative of the candidate substitute devices found by the management server 101 are sent to the PC 105 to be displayed on a display (not shown) of the PC 105. The user operating the PC 105 determines, based on the search results, which one of the candidate substitute devices is most suitable for the user to carry out the print operation. Then, the user causes the PC 105 to send data required for continuing the interrupted process to the device (apparatus) most suitable for the operation, and then causes the device (apparatus) to continue the interrupted print process.

Next, a device search process executed by the management server 101 (device search program 203) will be described with reference to FIG. 9.

The management server 101 (device search program 203) starts the device search process shown in FIG. 9, and monitors whether or not a search request has been received from a device (search requesting device) (step S101). When a search request is received from a device, the management server 101 sends search condition input screen information to the search requesting device (step S102).

Then, the management server 101 awaits receipt of search conditions (one or more search keys) from the search requesting device (step S103). When the one or more search keys are received from the search requesting device, the management server 101 refers to the database 300 to find devices associated with operation history information satisfying the received search conditions (step S104). Then, the management server 101 generates search result screen information indicative of the results of the device search and sends the generated information to the search requesting device (step S105). The device search result includes the name list of the found devices and additional information on the devices.

Then, the management server 101 monitors receipt of a search end request from the search requesting device (i.e. depression of the end button on the search result screen) (step S106) or receipt of a substitution request-starting request from the same (i.e. depression of the substitution request button on the search result screen) (step S107). When the search end request is received, the management server 101 terminates the present process (device search process). On the other hand, when the substitution request-starting request is received, the management server 101 starts the substitution request process described hereinafter.

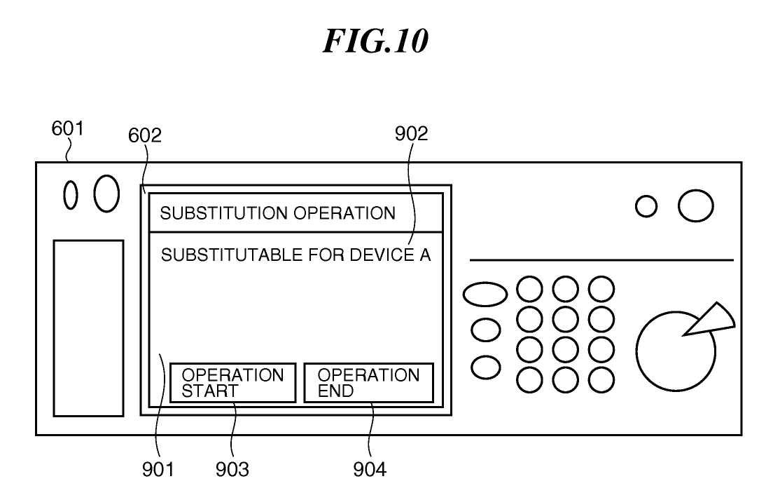

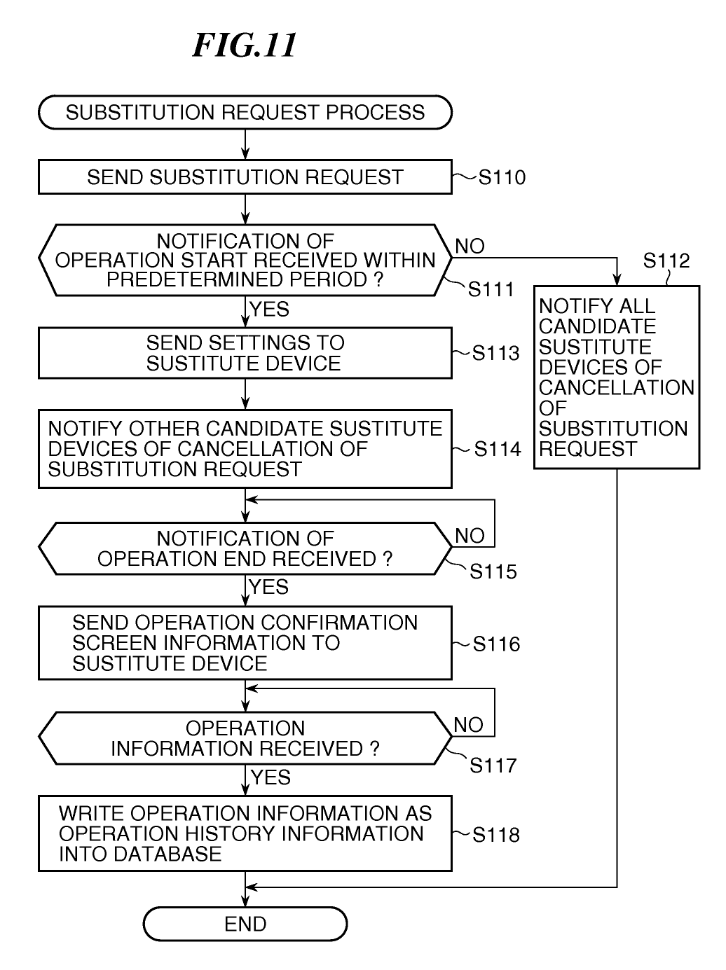

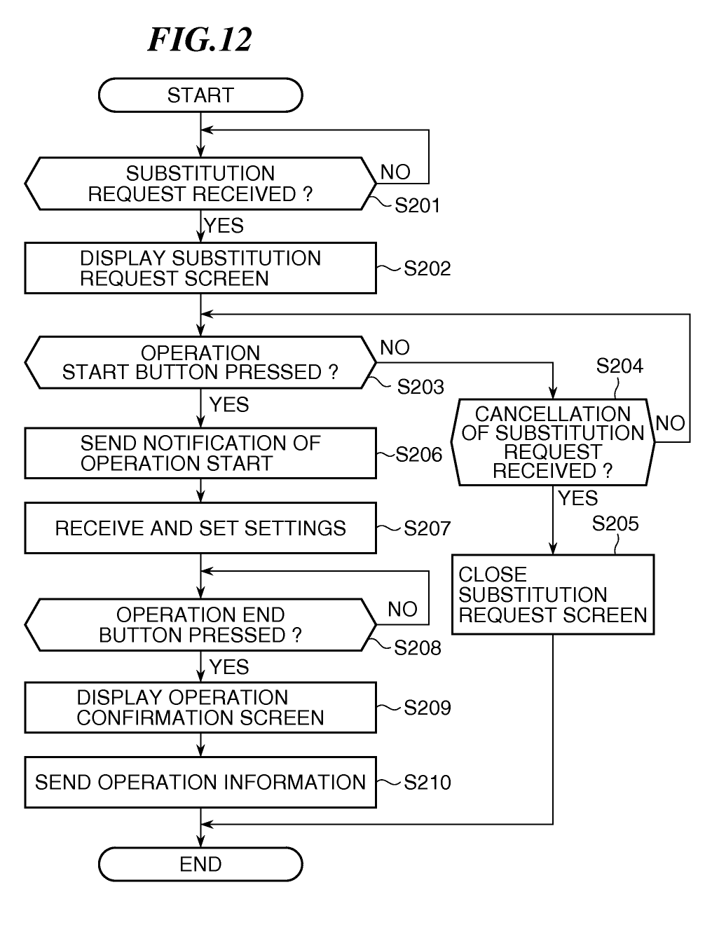

Next, the substitution request process performed by the management server 101 (substitution request program 204) will be described with reference to FIGS. 10 to 12. FIG. 10 is a view of an example of a screen displayed on the operating section so as to show candidate substitute devices found by device search by the management server 101. FIG. 11 is a flowchart of the substitution request process executed by the management server 101. FIG. 12 is a flowchart of a substitution process executed by a candidate substitute device having received a substitution request from the management server 101.

Now, a description will be given of a case where the substitution request button 705 is pressed on the search result screen 701 (see FIG. 8) of an MFP 103. In this case, the MFP 103 sends a substitution request-starting request including settings (settings for an interrupted operation) configured by the MFP 103 to the management server 101. When receiving the substitution request-starting request, the management server 101 finds a device which can continue the current operation in place of the MFP 103, and starts the substitution request process for requesting the device to continue the operation.

The management server 101 (substitution request program 204) issues the substitution request to each of the devices B to D (see FIG. 8) found as candidate substitute devices by the device search. The substitution request includes substitution request screen information for use in displaying a substitution request screen on each of the devices found as candidate substitute devices.

Each of the devices B to D displays a substitution request screen 901 appearing in FIG. 10 on the display section 602 of the operating section 601, based on the substitution request screen information included in the substitution request. The substitution request screen 901 displays a message 902 indicating that substitution for the device A is possible, an operation start button 903, and an operation end button 904. The substitution request screen 901 is kept displayed until substitution request cancellation is received from the management server 101. In short, the substitution request is canceled upon receipt of the substitution request cancellation.

Now, it is assumed that the user operating the MFP 103 refers to the additional information on each of the devices B to D, which is displayed on the search result screen 701, and determines the device B as a device suitable for carrying out the operation in place of the MFP 103. In this case, the user moves to a place where the device B is installed. Then, the user presses the operation start button 903 displayed on the display section 602 of the device B. By depression of the operation start button 903, the device B notifies the management server 101 that the operation will be started.

When notified of the operation start by the device B, the management server 101 sends settings for the operation interrupted in the MFP 103 to the device B. Further, the management server 101 notifies the other devices C and D of cancellation of the substitution request.

The device B receives the settings from the management server 101 and has itself configured for the operation according to the settings. Then, the user continues i.e. resumes the operation interrupted in the MFP 103, using the device B configured for the operation according to the settings. When the operation is completed, the user presses the operation end buttons 904. By depression of the operation end buttons 904, the device B notifies the management server 101 of completion of the operation.

Thus, simply by making a substitution request to one of the candidate substitute devices, the device selected as a substitute device from the candidate substitute devices by the user is configured for the operation according to the settings, so that the operation can be easily continued using the substitute device.

Next, the substitution request process executed by the management server 101 (substitution request program 204) will be described with reference to FIG. 11.

When receiving the substitution request-starting request from the search requesting device, the management server 101 starts the substitution request process shown in FIG. 11. Specifically, first of all, the management server 101 sends a substitution request to at least one of the candidate substitute devices found by device search (step S110). This substitution request includes substitution request screen information for use in displaying a substitution request screen on the display section of each of the one or more candidate substitute devices. Then, the management server 101 determines whether or not a notification of the start of the operation has been received from any of the one or more candidate substitute devices before the lapse of a predetermined time period after transmission of the substitution request (step S111).

If it is determined in the step S111 that the operation start notification is not received from any one of the candidate substitute devices within the predetermined time period, the management server 101 judges that the substitution request is canceled, and notifies all the candidate substitute devices of cancellation of the substitution request (step S112), followed by terminating the present process.

If it is determined in the step S111 that the operation start notification is received from one of the candidate substitute devices within the predetermined time period, the management server 101 sends the settings for the operation to the device (substitute device) having transmitted the operation start notification (step S113). When image data currently processed in the interrupted operation has already been stored in the storage device of the substitution requesting device, the image data is transferred together with the settings for the operation. When the operation currently carried out by the substitution requesting device is a copy operation and reading of originals has not been completed yet, the settings and information indicating how far the operation has advanced, etc. are transferred to the substitute device. Then, the user moves to the substitute device with originals remaining to be copied, and sets the originals in the substitute device, followed by carrying out the remaining part of the operation. At this time, the management server 101 determines that the device having transmitted the operation start notification is a substitute device for continuing the operation in place of the substitution requesting device. Then, the management server 101 notifies the other candidate substitute devices of cancellation of substitution request (step S114).

Then, the management server 101 awaits receipt of an operation end notification (i.e. depression of the operation end button) from the substitute device (step S115). Upon receipt of the operation end notification from the substitute device, the management server 101 sends operation confirmation screen information for use in displaying an operation confirmation screen to the substitute device (step S116). The user uses this operation confirmation screen to input e.g. information indicative of whether or not the remaining part of the operation has be normally performed by the substitute device.

Then, the management server 101 awaits receipt of operation information from the substitute device (step S117). The operation information from the substitute device includes not only information indicative of the operational conditions of the device, the user using the device, etc. but also information input from the operation confirmation screen. Upon receipt of the operation information, the management server 101 writes the received operation information into the database 300 as operation history information (step S118), followed by terminating the present process.

While the substitution request process is executed by the management server 101, the device (candidate substitute device) executes a substitution process shown in FIG. 12, and first determines whether or not a substitution request has been received from the management server 101 (step S201). If the substitution request has been received, the device displays the substitution request screen (see FIG. 10) on the display section 602 based on the substitution request screen information included in the substitution request (step S202). Then, the device determines whether or not the operation start button has been pressed by the user on the substitution request screen (step S203). If it is determined that the operation start button has not been pressed, the device determines whether or not a notification of substitution request cancellation has been received from the management server 101 (step S204). If the notification of substitution request cancellation has not been received, the process returns to the step S203, whereas if the notification of substitution request cancellation has been received, the device closes the substitution request screen (step S205), followed by terminating the present process.

If it is determined in the step S203 that the operation start button has been pressed, the device determines that it has been selected as a substitute device, and notifies the management server 101 that the operation will be started (step S206). Then, the device receives settings (image data as well, if any) sent from the management server 101 and is configured according to the settings (step S207). This enables the user to continue the operation using the device (substitute device) in place of the substitution requesting device.

Then, the device determines whether or not the operation end button has been pressed by the user on the substitution request screen (step S208). If the operation end button has been pressed, the device receives operation confirmation screen information from the management server 101, and displays an operation confirmation screen on the display section 602 based on the operation confirmation screen information (step S209). Then, the device sends operation information including information input by the user from the operation confirmation screen, to the management server 101 (step S210), followed by terminating the present process.

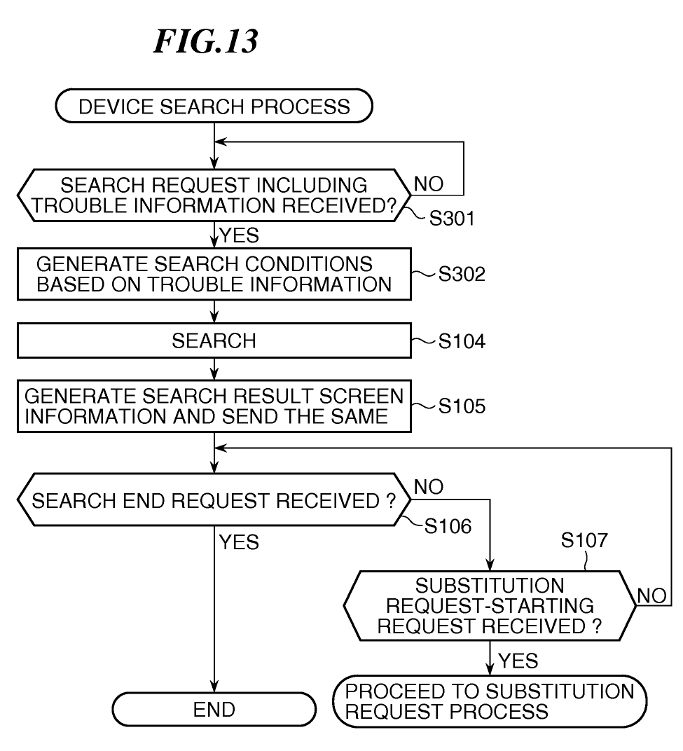

Next, a second embodiment of the present invention will be described with reference to FIG. 13. FIG. 13 is a flowchart of a device search process executed by a management server 101 of an image processing system according to the second embodiment.

The present embodiment is distinguished from the above-described first embodiment in that the management server 101 generates search conditions for searching for candidate substitute devices, based on the details of a trouble which caused operation interruption in a search requesting device. The other component elements and the like of the second embodiment are the same as those of the first embodiment, and are denoted by the same reference numerals, and description thereof is omitted.

Now, it is assumed that a trouble occurs with the scan function of an MFP 103 during execution of an operation for reading originals using the scan function and storing image data read from the originals in the external storage device 106, and the operation is interrupted. In this case, the MFP 103 sends a search request for finding a device to be substituted for the MFP 103 to the management server 101 according to the user's instruction. The MFP 103 sends trouble information indicative of the details of the trouble having occurred, together with the search request. The trouble information includes information on the fact that the scan function has failed and settings (reading resolution, etc.) for the scan function.

Upon receipt of the trouble information together with the search request, the management server 101 generates search conditions (search keys) for finding candidate substitute devices for the MFP 103, based on the trouble information. In the present example, one or more search keys (for designating e.g. the scan function and the reading resolution) for defining a scan function equivalent to that of the MFP 103 are generated as the search conditions. Then, the management server 101 refers to the database 300 to find devices associated with operation history information satisfying the generated one or more search keys, as candidate substitute devices.

Then, the management server 101 generates search result screen information for use in displaying a search result screen including a name list of the found candidate substitute devices, and sends the generated search result screen information to the MFP 103. If the search end request is received from the MFP 103, the management server 101 terminates the present process, whereas if the substitution request-starting request is received, the management server 101 sends a substitution request to each of the candidate substitute devices.

Next, a substitution request process executed by the management server 101 (substitution request program 204) will be described with reference to FIG. 14.

The management server 101 starts the substitution request process shown in FIG. 14, and monitors whether or not a substitution request and trouble information have been received from the device (substitution requesting device) (step S301). When receiving the trouble information together with the substitution request from the device, the management server 101 generates a search conditions (one or more search keys) for finding candidate substitute devices for the substitution requesting device, based on the trouble information (step S302). Then, the management server 101 refers to the database 300 to find devices associated with operation history information satisfying the generated one or more search keys, as candidate substitute devices (step S104).

Thereafter, the management server 101 proceeds to the steps S104 to S105 similarly to the device search process shown in FIG. 9.

As described above, according to the present embodiment, since the management server 101 generates the search conditions for finding a substitute device, it is possible to save the user's time and labor for inputting the search conditions.

In the above-described embodiment, search conditions are not necessarily limited to ones generated based on quite the same operation as an operation currently executed by a user. More specifically, the search conditions may be set based on an operation with different settings from those for the operation currently executed by the user, but identical in operation type (e.g. “copy” may be set as a condition when a copy operation is being executed, or the same apparatus type as that of an apparatus executing an operation may be set as a condition). Further, search may be performed after specifying a user. In this case, the user may be an operator himself or may be set to a different user than the operator. This makes it possible to find an optimal substitute device based on operation history information and user intention.

Further, the processes described in the above embodiments may be combined as deemed appropriate.

It is to be understood that the present invention may also be accomplished by supplying a system or an apparatus with a storage medium in which a program code of software, which realizes the functions of either of the above described embodiments, is stored, and causing a computer (or CPU or MPU) of the system or apparatus to read out and execute the program code stored in the storage medium.

In this case, the program code itself read from the storage medium realizes the functions of either of the above described embodiments, and therefore the program code and the storage medium in which the program code is stored constitute the present invention.

Examples of the storage medium for supplying the program code include a floppy (registered trademark) disk, a hard disk, a magnetic-optical disk, an optical disk, such as a CD-ROM, a CD-R, a CD-RW, a DVD-ROM, a DVD-RAM, a DVD-RW, or a DVD+RW, a magnetic tape, a nonvolatile memory card, and a ROM. Alternatively, the program may be downloaded via a network.

Further, it is to be understood that the functions of either of the above described embodiments may be accomplished not only by executing the program code read out by a computer, but also by causing an OS (operating system) or the like which operates on the computer to perform a part or all of the actual operations based on instructions of the program code.

Further, it is to be understood that the functions of either of the above described embodiments may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2008-122179 filed May 8, 2008, which is hereby incorporated by reference herein in its entirety.

What is claimed is:

1. An image processing system comprising:
an operation history information storage unit configured to collect operation information indicative of details of operations executed in each of a plurality of image processing apparatuses and store the collected operation information as operation history information;
an input unit configured to input search conditions for searching for a second image processing apparatus to be substituted for a first image processing apparatus, from among the plurality of image processing apparatuses;
a search unit configured to search for image processing apparatuses satisfying the search conditions from among the plurality of image processing apparatuses by referring to the operation history information stored in said operation history information storage unit; and
a display processing unit configured to carry out processing for causing a display unit to display results of the search by said search unit.

2. The image processing system according to claim 1, wherein when a trouble occurs in the first image processing apparatus, said input unit generates search conditions for searching for the second image processing apparatus to be substituted for the first image processing apparatus, based on details of the trouble having occurred in the first image processing apparatus, and inputs the generated search conditions.

3. The image processing system according to claim 1, further comprising a substitution request unit configured to request the second image processing apparatus included in the results of the search by said search unit to continue an operation currently executed by the first image processing apparatus.

4. The image processing system according to claim 3, wherein said substitution request unit transfers settings concerning the operation according to which the first image processing apparatus is configured, to the second image processing apparatus.

5. The image processing system according to claim 1, wherein the operation history information includes function information indicative of functions used for execution of the operations.

6. The image processing system according to claim 1, comprising a management information storage unit configured to store management information indicative of at least executable functions and an installation place in association with each of the image processing apparatuses, and
wherein said search unit generates search result information indicative of search results including a name of the second image processing apparatus and at least part of management information associated with the second image processing apparatus.

7. The image processing system according to claim 1, comprising a management information storage unit configured to store management information indicative of at least authorized users in association with each of the image processing apparatuses, and
wherein the operation history information includes function information indicative of functions used for execution of respective operations and user information indicative of users who executed the respective operations, and
wherein said search unit searches for image processing apparatuses which satisfy the search conditions and which a user executing an operation by the first image processing apparatus is authorized to use, by referring to the operation history information stored in said operation history information storage unit and the management information stored in said management information storage unit.

8. The image processing system according to claim 1, wherein the display unit is provided in the first image processing apparatus.

9. The image processing system according to claim 1, wherein the display unit is provided in an apparatus to which data to be processed by the first image processing apparatus is transferred.

10. A method of controlling an image processing system including a plurality of image processing apparatuses, comprising:
collecting operation information indicative of details of operations executed in each of the plurality of image processing apparatuses and storing the collected operation information as operation history information;
inputting search conditions for searching for a second image processing apparatus to be substituted for a first image processing apparatus, from among the plurality of image processing apparatuses;
searching for image processing apparatuses satisfying the search conditions from among the plurality of image processing apparatuses by referring to the stored operation history information; and
carrying out processing for causing a display unit to display results of the search.

11. The method according to claim 10, wherein when a trouble occurs in the first image processing apparatus, the search conditions are generated as search conditions for searching for the second image processing apparatus to be substituted for the first image processing apparatus, based on details of the trouble having occurred in the first image processing apparatus.

12. A computer-readable storage medium storing a program for causing a computer to execute a method of controlling an image processing system including a plurality of image processing apparatuses, comprising;
collecting operation information indicative of details of operations executed in each of the plurality of image processing apparatuses and storing the collected operation information as operation history information;
inputting search conditions for searching for a second image processing apparatus to be substituted for a first image processing apparatus, from among the plurality of image processing apparatuses;
searching for image processing apparatuses satisfying the search conditions from among the plurality of image processing apparatuses by referring to the stored operation history information; and
carrying out processing for causing a display unit to display results of the search.

13. The storage medium according to claim 12, wherein when a trouble occurs in the first image processing apparatus, the search conditions are generated as search conditions for searching for the second image processing apparatus to be substituted for the first image processing apparatus, based on details of the trouble having occurred in the first image processing apparatus.
